(19) United States
(12) Patent Application Publication
(10) Pub. No.: US 2010/0259485 A1
(43) Pub. Date: Oct. 14, 2010

(54) Touch keyboard input device enabling pattern switching

(76) Inventor: Cheng-Yen Chuang, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/385,427

(22) Filed: Apr. 8, 2009

(51) Int. Cl. G06F 3/041; G06F 3/048

(52) U.S. Cl. 345/173; 715/773

(57) ABSTRACT

In a touch keyboard input device enabling pattern switching, there are included a plurality of superposed light guide plates; a reflective sheet located below the superposed light guide plates; and a touch panel located beneath the reflective sheet. Each of the light guide plate is provided with a plurality of reflecting points to thereby form a specific pattern thereon. By switching among the light sources separately provided for the light guide plates, only the pattern on a lightened light guide plate can be displayed. And, the key position at where a user inputs can be detected using the touch panel or a triangulating device.

### FIELD OF THE INVENTION

The present invention relates to a touch keyboard input device enabling pattern switching, which has multiple layers of superposed light guide plates. By switching among different light sources separately provided for the light guide plates, only the pattern on a lightened light guide plate can be displayed. And, the key position at where a user inputs can be detected using a touch panel or a triangulating device.

### BACKGROUND OF THE INVENTION

On a conventional keyboard, different marks, such as English alphabets, numbers, characters or symbols, are directly imprinted on a plurality of keycaps, so that a user can conveniently know the meaning and functions corresponding to each key. Meanwhile, in response to different input methods or when the same key corresponds to different meaning and functions, it is usually necessary to imprint several different characters or marks on each keycap. For example, the same one keycap may have a letter “A”, a Mandarin phonetic symbol “ [symbol] ”, and a character component “ [symbol] ” in Cangjie input method imprinted thereon at the same time to indicate different meaning of the keycap. The keycap may be further imprinted with some special symbols. For example, the number keys at the right side of the standard 101 keyboard for general desktop computers can be switched to serve as function keys for controlling cursor movement, such as Up, Down, Left, and Right direction keys. Thus, on these keys, there are imprinted not only numbers, but also arrow marks or words indicating specific control functions, such as Home, End, PgUp, PgDn, etc.

When there are so many keycaps being arranged on the standard keyboard at the same time, the face of the keyboard looks very complicate and tends to cause visual confusion to a user sitting in front of the keyboard. The user, particularly a beginner in using a computer, would feel difficult in easily locate desired keys. Therefore, it is desirable to develop a keyboard that allows a user to switch among different input methods, so that only the characters or marks corresponding to a selected input method are displayed on the keycaps, or only marks or symbols corresponding to a selected function mode are displayed on the keycaps. In this manner, the keyboard would be more simple and easy for use.

FIG. 1 shows a conventional light guide plate 10, on which a plurality of reflecting points 11 is provided. The size and density of the reflecting points 11 distributed at different areas on the light guide plate 10 is variable and, basically, depends on a distance between each of the reflecting points to a light source 12. The reflecting points 11 can be produced by different ways, such as injection molding, die forming, or screen printing. Light beams 13 from the spot light source or linear light source 12 of the light guide plate 10 is incident on the light guide plate 10 and is changed in its direction by the reflecting points 11 to thereby exit from a light exit face 14 of the light guide plate 10. Moreover, uniform exit light can be achieved through selected size and density of distributed reflecting points 11 on the light guide plate 10.

Please refer to FIG. 2. For example, when the light guide plate 10 is associated with a pattern layer 20, the light beams 13 exited from the light exit face 14 of the light guide plate 10 is projected on to a pattern layer 20, which has predetermined designed light transmittable areas 21 and light non-transmittable areas 22. The light beams 13 exited from the light guide plate 10 is stopped by the light non-transmittable areas 22 from passing through the pattern layer 20 while the light transmittable areas 21 allow the light beams 13 to pass through the pattern layer 20, so that a user can still recognize the pattern shown on the pattern layer 20 even in an environment with insufficient external light source. That is, the conventional light guide plate plays only the role of providing a backlight, and the patterns to be shown, such as the digits and other characters and symbols, are determined by the pattern layer 20 overlaid on the backlight module. When the pattern layer on the keypad is removed, a user can usually see only an area light source formed as an effect of the light guide plate 10.

US Patent Publication No. 20050057915 entitled “Patterned Light guide Plate and Display Device Having Same” discloses a light guide plate that directly utilizes a plurality of reflecting points particularly arranged thereon to show a desired pattern. For this purpose, a bottom surface of the light guide plate has an imaginary grid drawn thereon to provide a plurality of squares. Each of the squares serves as a pixel. A wedged recess is formed at any of the squares that is to be used for showing a pattern. The wedged recess has a right-angled cross section, and an inclined plane bounding the recess obliquely faces toward an incident surface of the light guide plate. Areas on the light guide plate other than the wedged recesses are not processed to thereby maintain a planar surface. The inclined planes of the recesses are arranged into a pattern to be shown. The smaller the squares on the bottom surface of the light guide plate are, the clearer the pattern can be shown.

In the US Patent Publication No. 20050057915, the light guide plate is combined with the pattern layer, and is directly used to show a desired pattern. However, the patterned light guide plate as described above can show only one predetermined pattern, and therefore has relatively low utilization.

In addition, the keys on the conventional keyboard are generally of a switch type. That is, these keys are respectively controlled via a contact. When one key is pushed, the corresponding contact thereof is electrically connected, allowing a signal to be transmitted to a computer. And, when the key is released, the corresponding contact thereof is disconnected and the signal transmission is interrupted. In this manner, it is able to detect which key has been pushed. Moreover, the keys on the conventional keyboard have a keycap each. The keycap has a fixed height, and a predetermined distance is required for the contact of each key to move between a pushed and a released position. As a result, the conventional keyboard has a relatively large thickness that can not be effectively reduced.

### SUMMARY OF THE INVENTION

A primary object of the present invention is to provide a touch keyboard input device enabling pattern switching, which has multiple layers of superposed light guide plates. By switching among different light sources separately provided for the light guide plates, only the pattern on a lightened light guide plate can be displayed. And, the key position at where a user inputs can be detected using a touch panel or a triangulating device.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 schematically shows the application of a conventional light guide plate structure;

FIG. 2 schematically shows the application of a conventional light guide plate combined with a pattern layer;

FIG. 3 schematically shows a touch keyboard input device according to a first embodiment of the present invention;

FIG. 4 schematically shows a touch keyboard input device according to a second embodiment of the present invention;

FIG. 5 exemplifies one of many patterns that can be shown on the touch keyboard input device of the present invention; and

FIG. 6 exemplifies another pattern that can be shown on the touch keyboard input device of the present invention.

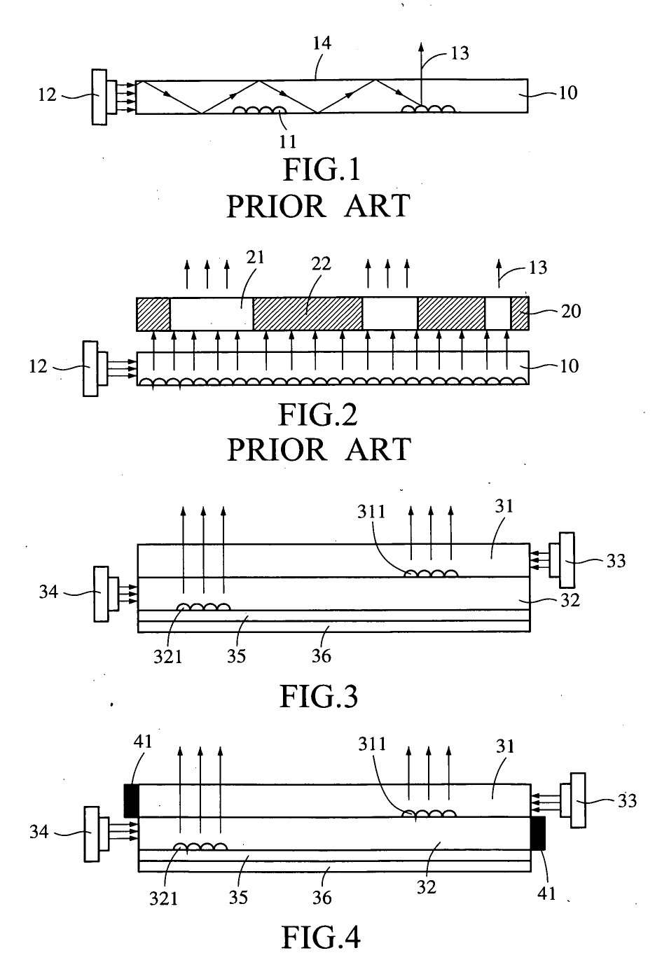

### DETAILED DESCRIPTION OF THE PREFERRED EMBODIMENTS

The present invention relates to a touch keyboard input device, which uses multiple layers of light guide plates to display characters or function marks that were generally directly imprinted on different keycaps of a conventional keyboard. Therefore, the touch keyboard input device of the present invention can replace the conventional keyboard. On each of the light guide plates, each position corresponding to one key on the touch keyboard only displays one specific character or mark or symbol. For example, corresponding to the position of the keyboard that shows the letter “A”, the first layer of light guide plate only displays the letter “A”, the second layer of light guide plate only displays the Mandarin phonetic symbol “ [symbol] ”, and the third layer of light guide plate only displays the character component “ [symbol] ” in Cangjie input method. For the layers of light guide plates to respectively display different characters or marks, the light guide plates are provided with printed reflecting points or die-forming dots to form a pattern showing the desired characters or marks, and a light source is mounted to a lateral side of each of the light guide plates. When a light beam emitted from the light source enters the corresponding light guide plate, the light beam propagates forward due to total internal reflection in the light guide plate. When the light beam reaches at the microstructure of the printed reflecting points or the die-forming dots, the total internal reflection is disrupted, and the light beam exits the light guide plate from a front face thereof to thereby display the characters or marks. That is, when only the light source of the first layer of light guide plate is lightened, the touch of different key positions on the touch keyboard will only display the characters or the marks corresponding to the patterned reflecting points or dots on the first layer of light guide plate, such as the above mentioned letter “A”. And, when only the light source of the second layer of light guide layer is lightened, the touch of different key positions on the touch key board will only display the characters or the marks corresponding to the patterned reflecting points or dots on the second layer of light guide plate, such as the above mentioned Mandarin phonetic symbol “ [symbol] ”. Similarly, when only the light source of the third layer of light guide layer is lightened, the touch of different key positions on the touch keyboard will only display the characters or the marks corresponding to the patterned reflecting points or dots on the third layer of light guide plate, such as the above mentioned character component “ [symbol] ” in Cangjie input method. Therefore, by controlling the on or off of the light sources for different layers of light guide plates, it is able to switch among the patterns provided on different light guide plates of the touch keyboard. The pattern switching can be implemented by providing a switch device on the keyboard or through control with software.

Meanwhile, the touch keyboard of the present invention uses a touch panel or a triangulating device to replace the input method using contact control. The touch panel can be a capacitive touch panel or a resistive touch panel. The triangulating device can utilize a light source or a sensor to perform triangulation location. With the touch keyboard of the present invention, the keycaps for the conventional keyboard can be omitted, and it is not necessary to provide space for the contact to move between a pushed and a released position. Therefore, the touch keyboard of the present invention can have a largely reduced thickness that is only about one fifth (⅕) of the thickness of the conventional keyboard.

Please refer to FIG. 3 that schematically shows a touch keyboard input device enabling pattern switching according to a first embodiment of the present invention. As shown, the touch keyboard input device according to the present invention includes a plurality of superposed light guide plates. In the illustrated first embodiment, there are two superposed light guide plates, namely, a first and a second light guide plate 31, 32. The touch keyboard input device of the present invention also includes light sources in a number the same as that of the light guide plates. Therefore, in the illustrated first embodiment, there are two light sources, namely, a first and a second light source 33, 34 corresponding to the first and the second light guide plate 31, 32, respectively. The first light source 33 is located near one lateral side of the first light guide plate 31, and the second light source 34 is located near one lateral side of the second light guide plate 32. The touch keyboard input device of the present invention further includes a reflective sheet 35 being provided to a bottom face of the second light guide plate 32 to prevent light beams from passing through the bottom face of the second light guide plate 32, and a transparent touch panel 36 located beneath the reflective sheet 35 for detecting a key position at where a user inputs. The first and the second light guide plate 31, 32 are respectively provided with a pattern formed by a plurality of reflecting points 311, 321. The reflecting points 311, 321 cooperate with the light sources 33, 34, respectively, to show the pattern on the first or the second light guide plate 31, 32.

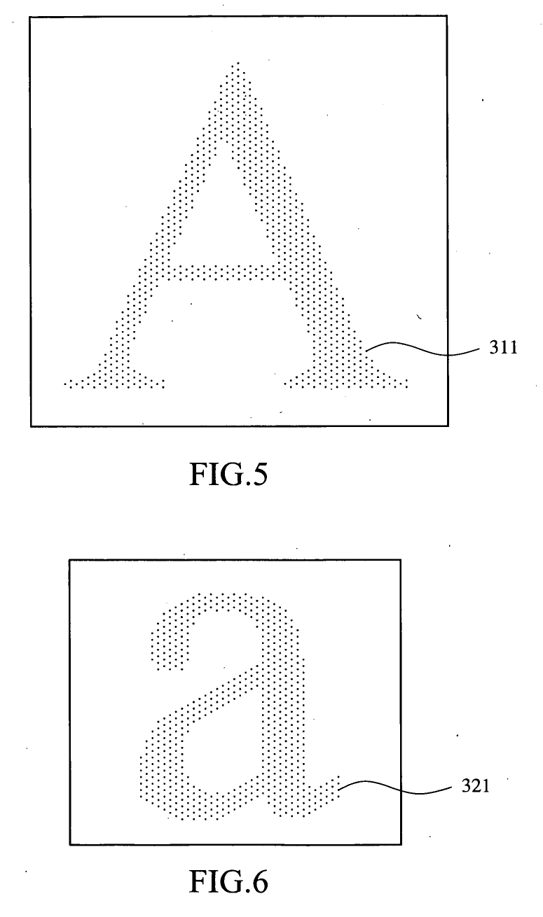

When it is desired to show the pattern on the first light guide plate 31, simply actuate the first light source 33 to irradiate light beams on the first light guide plate 31. Meanwhile, the second light source 34 for irradiating the second light guide plate 32 is turned off. Light beams from the first light source 33 are incident on and propagate through the first light guide plate 31 via total internal reflection. When reaching at the reflecting points 311, light paths of some of the light beams from the first light source 33 are interfered to thereby turn upward and exit from an upper light exit face of the first light guide plate 31. That is, the reflecting points 311 on the first light guide plate 31 will become bright. Meanwhile, other light beams from the first light source 33 that are not interfered by the reflecting points 311 will maintain their light paths to continuously propagate through the first light guide plate 31. As a result, areas on the first light guide plate 31 that are not provided with the reflecting points 311 are relatively dark to form a background of the pattern formed by the reflecting points 311. For example, the first light guide plate 31 can have reflecting points 311 that together form an uppercase English letter “A”, as shown in FIG. 5. When the first light source 33 is actuated, the letter “A” can be seen at the light exit face of the first light guide plate 31. On the other hand, when it is desired to show a pattern on the second light guide plate 32, simply actuate the second light source 34 to irradiate light beams on the second light guide plate 34 while turn off the first light source 33 to stop irradiating the first light guide plate 31. Light beams from the second light source 34 are incident on and propagate through the second light guide plate 32 via total internal reflection. When reaching at the reflecting points 321, light paths of some of the light beams from the second light source 34 are interfered to thereby turn upward and exit from an upper light exit face of the second light guide plate 32 and pass through the first light guide plate 31, which is highly transparent. That is, the reflecting points 321 on the second light guide plate 32 will become bright. Meanwhile, other light beams from the second light source 34 that are not interfered by the reflecting points 321 will maintain their light paths to continuously propagate through the second light guide plate 32. As a result, areas on the second light guide plate 32 that are not provided with the reflecting points 321 are relatively dark to form a background of the pattern formed by the reflecting points 321. For example, the second light guide plate 32 can have reflecting points 321 that together form a lowercase English letter “a”, as shown in FIG. 6. When the second light source 34 is actuated, the letter “a” can be seen at the light exit face of the second light guide plate 32.

FIG. 4 schematically shows a touch keyboard input device according to a second embodiment of the present invention. The second embodiment is generally structurally similar to the first embodiment. Therefore, like components in the two embodiments are denoted by the same reference numerals. The second embodiment is different from the first one in having a light-blocking structure 41. To prevent light leakage, in the second embodiment, the first and the second light guide plate 31, 32 are provided at respective one lateral side opposite to the first and the second light source 33, 34 with a light-blocking structure 41. For example, the light-blocking structure 41 can be black ink coated on one lateral side of the light guide plates 31, 32, or a light-blocking tape attached to one lateral side of the light guide plates 31, 32, so that light beams from the first light source 33 could not be incident on the second light guide plate 32, and light beams from the second light source 34 could not be incident on the first light guide plate 31. That is, light beams from different light sources are not interfered by one another.

In brief, in the present invention, a plurality of light guide plates with patterns formed by reflecting points is superposed, and a plurality of light sources in the same number as the light guide plates is provided. Therefore, by switching among the light sources, a different light guide plate can be lightened to show the dotted pattern provided thereon. In this manner, a user can more easily identify the characters and marks provided on the keyboard.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A touch keyboard input device enabling pattern switching, comprising:
a plurality of light guide plates, each of which has a pattern formed by a plurality of reflecting points provided on the light guide plate, and the light guide plates being sequentially superposed; and
a plurality of light sources in a number the same as that of the light guide plates, so that each of the light sources corresponds to one of the light guide plates to serve as a specific light source thereof;
a reflective sheet being located below the light guide plates; and
a touch panel being located beneath the reflective sheet for receiving a touch key position at where a user inputs.

2. The touch keyboard input device enabling pattern switching as claimed in claim 1, wherein each of the light sources is located near one lateral side of the corresponding light guide plate.

3. The touch keyboard input device enabling pattern switching as claimed in claim 1, further comprising a light-blocking structure being provided to one lateral side of each of the light guide plates opposite to the light source for that light guide plate.
